(19) United States
(12) Patent Application Publication
(10) Pub. No.: US 2015/0143192 A1
(43) Pub. Date: May 21, 2015

(54) APPLICATION SERVER AND METHOD OF ERROR RECOVERY WHEN DOWNLOADING DATA FILES

(71) Applicants: HONG FU JIN PRECISION INDUSTRY (Shenzhen) CO., LTD, Shenzhen (CN); HON HAI PRECISION INDUSTRY CO., LTD., New Taipei (TW)

(72) Inventors: Chung-I Lee, New Taipei (TW); Hai-Hong Lin, Shenzhen (CN); De-Yi Xie, Shenzhen (CN); Hai-Yun Chen, Shenzhen (CN); An-Sheng Luo, Shenzhen (CN)

(73) Assignee: HON HAI PRECISION INDUSTRY CO., LTD., New Taipei (TW)

(21) Appl. No.: 13/879,620

(22) PCT Filed: Jul. 18, 2012
(86) PCT No.: PCT/CN12/78806

§ 371 Date: Apr. 15, 2013

(30) Foreign Application Priority Data
Apr. 28, 2012 (CN) 201210129892.6

(51) Int. Cl. G06F 11/08; H04L 29/08

(52) U.S. Cl. CPC G06F 11/08; H04L 67/1097
USPC 714/747

(57) ABSTRACT

In a method of error recovery when downloading data files using an application server, the application server connects to at least one terminal device and several file servers. The application server receives a file downloading request from the terminal device, finds a first file server nearest to the terminal device, and downloads the required data file from the first file server to the terminal device. The application server searches a file configuration table to find a second file server which is away from the first file server when the data file has not been successfully downloaded from the first file server, downloads the required data file from the second file server to the terminal device, and synchronizes the data file of the second file server to recovery the data file of the first file server when the data file has been successfully downloaded from the second file server.

### BACKGROUND

1. Technical Field

Embodiments of the present disclosure relate to file downloading systems and methods, and particularly to an application server and a method of error recovery when downloading data files.

2. Description of Related Art

A feature of the Internet is the ability to transmit data files from one computer to another using various file transfer protocols such as File Transfer Protocol (FTP) and Hypertext Transfer Protocol (HTTP). Data files available to be downloaded from file servers are increasingly larger in size resulting in increased overall download times. As a result, downloading files over the Internet can be a time consuming process that often leads to problems occurring during the downloading process.

The downloading process is occasionally interrupted due to a network connection between a client devices and a file server. Additionally, a file may be corrupted during a downloading process due to a hardware or software malfunction of the file server, rendering the downloaded file unreadable or otherwise unusable. An interrupted file download must be downloaded again in its entirety, even if most of the file had already been downloaded at the time of the interruption or failure. Therefore, successfully downloading files over the Internet may require multiple attempts to process abnormalities in the file downloading process.

### BRIEF DESCRIPTION OF THE DRAWINGS

FIG. 1 is a block diagram of one embodiment of an application server including a file error recovery system.

FIG. 2 is a flowchart of one embodiment of a method of error recovery when downloading data files using the application server of FIG. 1.

FIG. 3 shows one exemplary embodiment of a file configuration table stored in a storage device of the application server.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In the present disclosure, the word “module,” as used herein, refers to logic embodied in hardware or firmware, or to a collection of software instructions, written in a program language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage system. Some non-limiting examples of a non-transitory computer-readable medium include CDs, DVDs, flash memory, and hard disk drives.

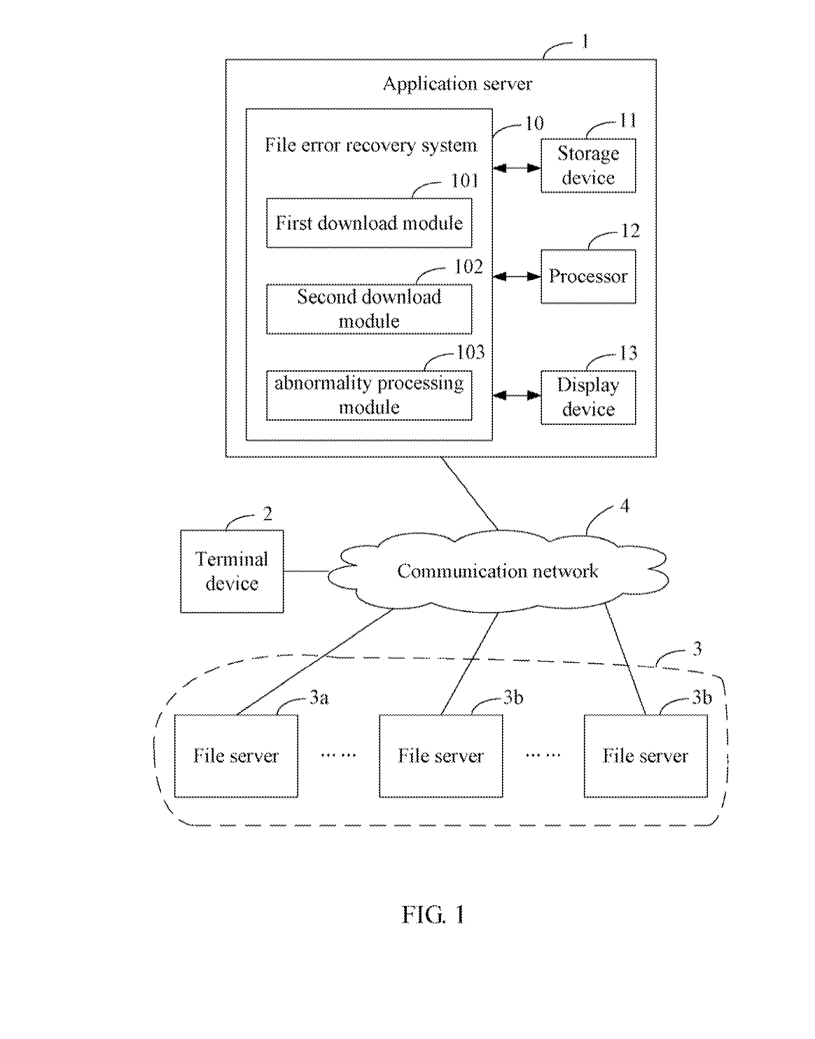

FIG. 1 is a block diagram of one embodiment of an application server 1 including a file error recovery system 10. The application server 1 connects to a least one terminal device 2 and a plurality of file servers 3 through a communication network 4. In the embodiment, the application server 1 is a host computer that runs the file error recovery system 10 to process the abnormality when downloading data files from the file servers 3, and to recover corrupted data file stored in the file servers 3. The terminal device 2 may be a PC computer, a workstation computer, a PDA device or any mobile electronic device, and is used to download the data files from the file servers 3 through the communication network 4. Each of the file servers 3 may be a network storage device or server for storing electronic data files to be downloaded by the terminal device 2. The communication network may be the Internet, an intranet network, a wide area network (WAN) or a local area network (LAN).

The application server 1 may further include a storage device 11, at least one processor 12, and a display device 13. In the embodiment, the system 10 may include computerized instructions in the form of one or more programs that are stored in the storage device 11 and executed by the at least one processor 12. FIG. 1 illustrates only one example of the application server 1, other examples may include more or fewer components than illustrated, or have a different configuration of the various components in other embodiments.

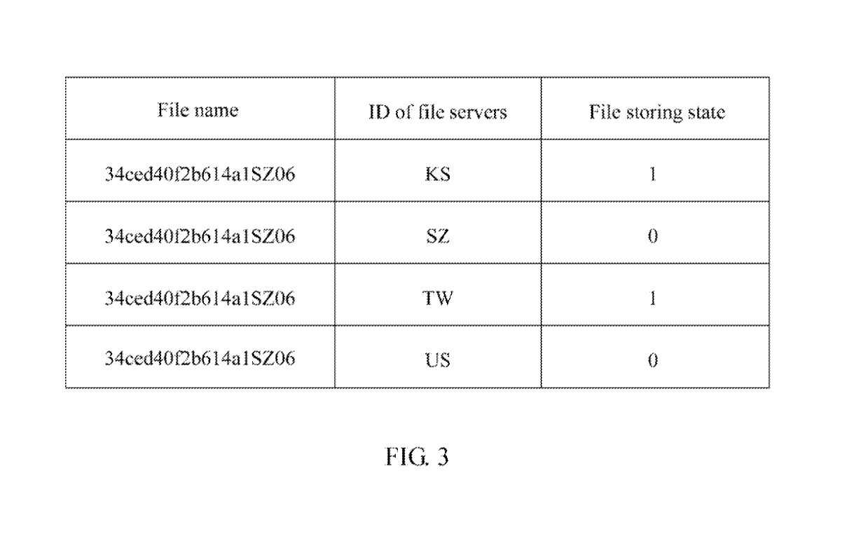

The storage device 11 stores a file configuration table for recording storage information of all the data files to be downloaded from the file servers 3. Referring to FIG. 3, the file configuration table includes a file name of each of the data files stored in each of the file servers 3, an identification (ID) of each of the file servers 3, and a file storing state of the data files indicating which file server 3 stores the data files. For example, assuming that a data file whose file name is “34ced40f2b614a1SZ06” is stored in four file servers 3 whose IDs are “KS”, “SZ”, “TW” and “US.” The ID “KS” indicates that the file server 3 is located in KunShan area, the ID “SZ” indicates that the file server 3 is located in ShenZhen area, the ID “TW” indicates that the file server 3 is located in Taiwan, and the ID “US” indicates that the file server 3 is located in the United states. The characterizations “0” and “1” indicate the storing state of a data file, “0” indicates that the data file does not exist in a file server 3, and “1” indicates that the data file does exist in a file server 3.

In one embodiment, each of the file servers 3 is located in a different area, such as KunShan and ShenZhen in China, in Taiwan, or in United States of America. The file servers 3 are divided into different groups according to the different locations. Referring back to FIG. 1, the file servers 3 are logically divided into a first file server 3a and a second file server 3b according the location of each of the file servers 3. In the embodiment, the system 10 ensures that the terminal device 2 downloads a data file from one of the file servers 3 (i.e., the second file server 3b) when the data file is unsuccessfully downloaded from another file server 3 (i.e., the first file server 3a), and synchronizes the data file from the second file server 3b to enable recovery of the unsuccessfully downloaded data file from the first file server 3a.

In one embodiment, the file error recovery system 10 includes a first download module 101, a second download module 102, and an abnormality processing module 103. The modules 101-103 may comprise computerized instructions in the form of one or more programs that are stored in the storage device 11 and executed by the at least one processor 12. In one embodiment, the storage device 11 may be an internal storage system, such as a random access memory (RAM) for temporary storage of information, and/or a read only memory (ROM) for permanent storage of information. A detailed description of each module will be given in the following paragraphs.

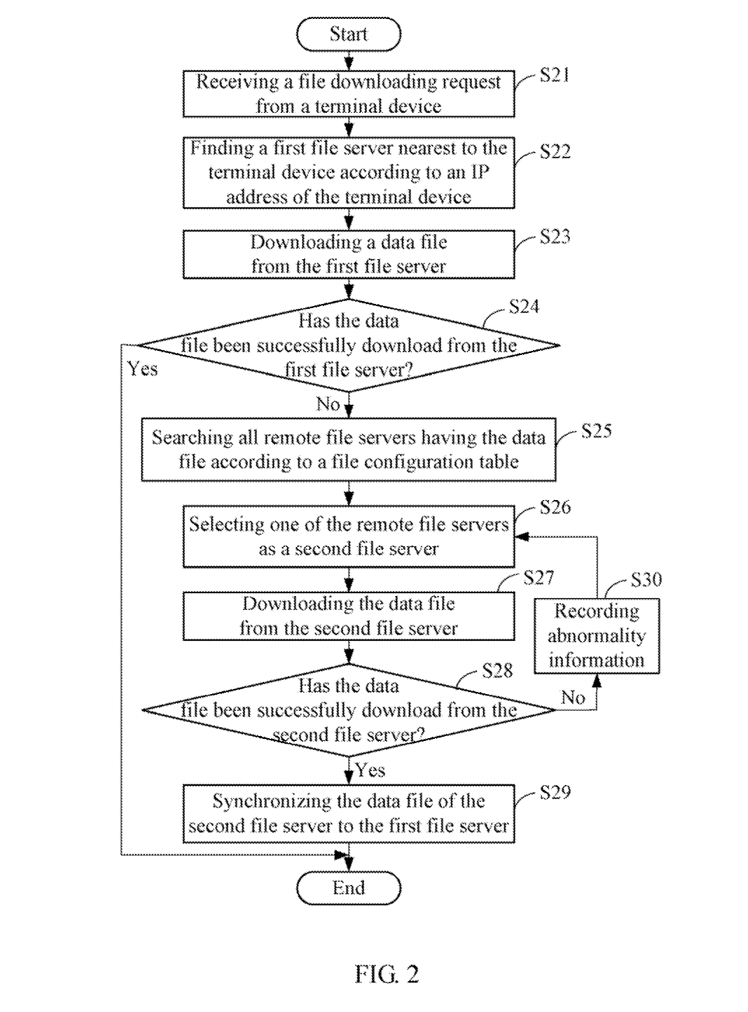

FIG. 2 is a flowchart of one embodiment of a method of error recovery when downloading files using the application server 1 of FIG. 1. The method is performed by execution of a computer-readable program code by at least one processor 12 of the application server 1 in FIG. 1. Depending on the embodiment, additional steps may be added, others removed, and the ordering of the steps may be changed.

In step S21, the first download module 101 receives a file downloading request from the terminal device 2. In the embodiment, the file downloading request includes an IP address of the terminal device 2, and a file name of a data file to be downloaded from one of the file servers 3.

In step S22, the first download module 101 finds the first file server 3a nearest to the terminal device 2 according to the file downloading request. In the embodiment, the first download module 101 searches all the file server 3 to find the first file server 3a according to the internet protocol (IP) address of the terminal device 2, and determines whether the data file exists in the first file server 3a according to the file name and the recorded file storing state of the data file.

In step S23, the first download module 101 downloads the data file from the first file server 3a to the terminal device 2 if the data file exists in the first file server 3a.

In step S24, the first download module 101 determines whether the data file has been successfully downloaded from the first file server 3a. If the data file has been successfully downloaded from the first file server 3a, the procedure is ended. If the data file has not been downloaded successfully from the first file server 3a, step S25 is implemented. In the embodiment, if the data file has not been successfully downloaded from the first file server 3a, the first download module 101 determines that the data file may be damaged in the first file server 3a.

In step S25, the second download module 102 searches the file configuration table to find all remote file servers 3 which are away from the first file server 3a. In the embodiment, the file configuration table includes a file name of each of the data files stored in each of the file servers 3, an identification (ID) of each of the file servers 3, and a file storing state of the data files indicating which file server 3 stores the data files.

In step S26, the second download module 102 selects one of the remote file servers 3 which does have the data file, as the second file server 3b. In the embodiment, the second download module 102 determines whether the data file exists in the remote file servers 3 according to the file storing state of the data file, and selects a remote file server 3 which has the data file, as the second file server 3b. Referring to FIG. 3, the second download module 102 finds two remote file servers 3 whose ID is “KS” and “TW”, and checks the file storing state of the data file to determine one of the remote file servers 3, whose IDs are “KS” and “TW,” as the second file server 3b.

In step S27, the second download module 102 downloads the data file from the second file server 3b through the communication network 4.

In step S28, the second download module 102 determines whether the data file has been successfully downloaded from the second file server 3b. If the data file has been successfully downloaded from the second file server 3b, step S29 is implemented. If the data file has not been downloaded successfully from the second file server 3b, step S30 is implemented.

In step S29, the abnormality processing module 103 synchronizes the data file from the second file server 3b to recover the data file of the first file server 3a. That is to say, the abnormality processing module 103 sends the downloaded data file to the first file server 3a, and stores the downloaded data file into the first file server 3a to update, correct, and complete the incomplete or corrupted data file stored in the first file server 3a.

In step S30, the abnormality processing module 103 records abnormality information of the data file downloading process when the data file has not been downloaded from the second file server 3b successfully, displays the abnormality information on the display device 13, and then step S26 is repeated to select another remote file server 3 to download the data file.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. An application server being connected to at least one terminal device and a plurality of file servers through a communication network, the application server comprising:
a storage device that stores a file configuration table;
at least one processor; and
one or more programs stored in the storage device and executed by the at least one processor, the one or more programs comprising:
a first download module that receives a file downloading request from the terminal device, the file downloading request comprising an internet protocol (IP) address of the terminal device and a file name of a data file to be downloaded from one of the file servers, finds a first file server nearest to the terminal device according to the IP address of the terminal device, downloads the data file from the first file server to the terminal device according to the file name of the data file, and determines if the data file has successfully been downloaded from the first file server;
a second download module that searches the file configuration table to find all remote file servers which are away from the first file server when the data file has not been downloaded from the first file server successfully, selects one of the remote file servers as a second file server, downloads the data file from the second file server to the terminal device according to the file name of the data file, and determines if the data file has been successfully downloaded from the second file server; and
an abnormality processing module that synchronizes the data file from the second file server to recover the data file stored in the first file server when the data file has been successfully downloaded from the second file server.

2. The application server according to claim 1, wherein the abnormality processing module records abnormality information of the data file downloading process when the data file has not been successfully downloaded from the second file server, and displays the abnormality information on a display device of the application server.

3. The application server according to claim 1, wherein the abnormality processing module sends the downloaded data file to the first file server when the data file has been successfully downloaded from the second file server, and stores the downloaded data file into the first file server to update, correct, and complete the corrupted data file stored in the first file server.

4. The application server according to claim 1, wherein the file configuration table comprises file names of data files stored in each of the file servers, an identification (ID) of each of the file servers, and a file storing state of each of the data files indicating which file server stores the data files.

5. The application server according to claim 1, wherein the second download module further determines whether the data file exists in the remote file servers according to the file storing state of the data file, and selects a remote file server which has the data file as the second file server.

6. The application server according to claim 1, wherein the file servers are actually located in different areas, and are logically divided into different groups according to the different locations.

7. A method of error recovery when downloading data files using an application server, the application server being connected to at least one terminal device and a plurality of file servers through a communication network, the method comprising steps of:
receiving a file downloading request from the terminal device, the file downloading request comprising an internet protocol (IP) address of the terminal device and a file name of a data file to be downloaded from one of the file servers;
finding a first file server nearest to the terminal device according to the IP address of the terminal device;
downloading the data file from the first file server to the terminal device according to the file name of the data file;
determining if the data file has been successfully downloaded from the first file server;
searching a file configuration table to find all remote file servers which are away from the first file server when the data file has not been successfully downloaded from the first file server;
selecting one of the remote file servers as a second file server;
downloading the data file from the second file server to the terminal device according to the file name of the data file;
determining if the data file has been successfully downloaded from the second file server; and
synchronizing the data file from the second file server to recover the data file stored in the first file server when the data file has been successfully downloaded from the second file server.

8. The method according to claim 7, further comprising:
recording abnormality information of the data file downloading process when the data file has not been successfully downloaded from the second file server; and
displaying the abnormality information on a display device of the application server.

9. The method according to claim 7, wherein the file configuration table is stored in a storage device of the application server, and comprises file names of data files stored in each of the file servers, an identification (ID) of each of the file servers, and a file storing state of each of the data files indicating which file server stores the data files.

10. The method according to claim 7, wherein the selecting step comprising:
determining whether the data file exists in the remote file servers according to the file storing state of the data file; and
selecting a remote file server which has the data file as the second file server.

11. The method according to claim 7, wherein the synchronizing step comprises:
sending the downloaded data file to the first file server when the data file has been successfully downloaded from the second file server; and
storing the downloaded data file into the first file server to update, correct, and complete the corrupted data file of the first file server.

12. The method according to claim 7, wherein the file servers are actually located in different areas, and are logically divided into different groups according to the different locations.

13. A non-transitory storage medium having stored thereon instructions that, when executed by at least one processor of an application server, causes the application server to perform a method of error recovery when downloading data files, the application server being connected to at least one terminal device and a plurality of file servers through a communication network, the method comprising steps of:
receiving a file downloading request from the terminal device, the file downloading request comprising an internet protocol (IP) address of the terminal device and a file name of a data file to be downloaded from one of the file servers;
finding a first file server nearest to the terminal device according to the IP address of the terminal device;
downloading the data file from the first file server to the terminal device according to the file name of the data file;
determining if the data file has been downloaded from the first file server successfully;
searching a file configuration table to find all remote file servers which are away from the first file server when the data file has not been successfully downloaded from the first file server;
selecting one of the remote file servers as a second file server;
downloading the data file from the second file server to the terminal device according to the file name of the data file;
determining if the data file has been successfully downloaded from the second file server; and
synchronizing the data file from the second file server to recover the data file stored in the first file server when the data file has been successfully downloaded from the second file server.

14. The storage medium according to claim 13, wherein the method further comprises:
recording abnormality information of the data file downloading process when the data file has not been successfully downloaded from the second file server; and
displaying the abnormality information on a display device of the application server.

15. The storage medium according to claim 13, wherein the file configuration table is stored in a storage device of the application server, and comprises file names of data files stored in each of the file servers, an identification (ID) of each of the file servers, and a file storing state of each of the data files indicating which file server stores the data files.

16. The storage medium according to claim 13, wherein the selecting step comprises:
determining whether the data file exists in the remote file servers according to the file storing state of the data file; and
selecting a remote file server which has the data file as the second file server.

17. The storage medium according to claim 13, wherein the synchronizing step comprises:
sending the downloaded data file to the first file server when the data file has been successfully downloaded from the second file server; and
storing the downloaded data file into the first file server to update, correct, and complete the corrupted data file of the first file server.

18. The storage medium according to claim 13, wherein the file servers are actually located in different areas, and are logically divided into different groups according to the different locations.
